(19) United States
(12) Patent Application Publication
(10) Pub. No.: US 2026/0082328 A1
(43) Pub. Date: Mar. 19, 2026

(54) UE MONITORING FOR LOW POWER WUS

(71) Applicant: Nokia Technologies Oy, Espoo (FI)

(72) Inventors: Knud KNUDSEN, Aalborg (DK); Daniela LASELVA, Aalborg (DK); Jussi-Pekka KOSKINEN, Oulu (FI); Mads LAURIDSEN, Aalborg (DK); Jan Torst HVIID, Aalborg (DK)

(21) Appl. No.: 19/110,525

(22) PCT Filed: Sep. 7, 2023
(86) PCT No.: PCT/EP2023/074536

§ 371 Date: Mar. 11, 2025

(30) Foreign Application Priority Data
Sep. 15, 2022 (FI) 20225804

(51) Int. Cl. H04W 52/02; H04B 17/318; H04L 43/0817

(52) U.S. Cl. CPC H04W 52/0235; H04B 17/328; H04L 43/0817

(57) ABSTRACT

An apparatus configured to: receive a configuration for monitoring behavior; determine whether the apparatus is in a first radio coverage area based, at least partially, on the received configuration; determine a monitoring behavior based on whether the apparatus is in the first radio coverage area, wherein the monitoring behavior comprises a first monitoring behavior based on a determination that the apparatus is in the first radio coverage area, wherein the monitoring behavior comprises a second monitoring behavior based on a determination that the apparatus is outside the first radio coverage area, wherein the first monitoring behavior is at least partially different from the second monitoring behavior; and perform the determined monitoring behavior.

### TECHNICAL FIELD

The example and non-limiting embodiments relate generally to user equipment (UE) monitoring behavior and, more particularly, to control of UE monitoring.

### BACKGROUND

It is known, in network communication, to transmit a keep-alive signal to a UE.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: receive a configuration for monitoring behavior; determine whether the apparatus is in a first radio coverage area based, at least partially, on the received configuration; determine a monitoring behavior based on whether the apparatus is in the first radio coverage area, wherein the monitoring behavior comprises a first monitoring behavior based on a determination that the apparatus is in the first radio coverage area, wherein the monitoring behavior comprises a second monitoring behavior based on a determination that the apparatus is outside the first radio coverage area, wherein the first monitoring behavior is at least partially different from the second monitoring behavior; and perform the determined monitoring behavior.

In accordance with one aspect, a method comprising: receiving, with a user equipment, a configuration for monitoring behavior; determining whether the user equipment is in a first radio coverage area based, at least partially, on the received configuration; determining a monitoring behavior based on whether the user equipment is in the first radio coverage area, wherein the monitoring behavior comprises a first monitoring behavior based on a determination that the user equipment is in the first radio coverage area, wherein the monitoring behavior comprises a second monitoring behavior based on a determination that the user equipment is outside the first radio coverage area, wherein the first monitoring behavior is at least partially different from the second monitoring behavior; and performing, with the user equipment, the determined monitoring behavior.

In accordance with one aspect, an apparatus comprising means for performing: receiving a configuration for monitoring behavior; determining whether the apparatus is in a first radio coverage area based, at least partially, on the received configuration; determining a monitoring behavior based on whether the apparatus is in the first radio coverage area, wherein the monitoring behavior comprises a first monitoring behavior based on a determination that the apparatus is in the first radio coverage area, wherein the monitoring behavior comprises a second monitoring behavior based on a determination that the apparatus is outside the first radio coverage area, wherein the first monitoring behavior is at least partially different from the second monitoring behavior; and causing performance of the determined monitoring behavior.

In accordance with one aspect, a non-transitory computer-readable medium comprising program instructions stored thereon for performing at least the following: receiving a configuration for monitoring behavior; determining whether a user equipment is in a first radio coverage area based, at least partially, on the received configuration; determining a monitoring behavior based on whether the user equipment is in the first radio coverage area, wherein the monitoring behavior comprises a first monitoring behavior based on a determination that the user equipment is in the first radio coverage area, wherein the monitoring behavior comprises a second monitoring behavior based on a determination that the user equipment is outside the first radio coverage area, wherein the first monitoring behavior is at least partially different from the second monitoring behavior; and causing performance of the determined monitoring behavior.

In accordance with one aspect, an apparatus comprising: at least one processor; and at least one memory storing instructions that, when executed by the at least one processor, cause the apparatus at least to: transmit, to a user equipment, a configuration for monitoring behavior, wherein the configuration comprises, at least, an indication of network information associated with user equipment selection of monitoring behavior.

In accordance with one aspect, a method comprising: transmitting, to a user equipment, a configuration for monitoring behavior, wherein the configuration comprises, at least, an indication of network information associated with user equipment selection of monitoring behavior.

In accordance with one aspect, an apparatus comprising means for performing: transmitting, to a user equipment, configuration for monitoring behavior, wherein the configuration comprises, at least, indication of network information associated with user equipment selection of monitoring behavior.

In accordance with one aspect, a non-transitory computer-readable medium comprising program instructions stored thereon for performing at least the following: causing transmitting, to a user equipment, of a configuration for monitoring behavior, wherein the configuration comprises, at least, an indication of network information associated with user equipment selection of monitoring behavior.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4 is a diagram illustrating features as described herein;

FIG. 5 is a diagram illustrating features as described herein;

FIG. 6 is a signalchart illustrating steps as described herein;

FIG. 7 is a flowchart illustrating steps as described herein; and

FIG. 8 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
AMF access and mobility management function
C-DRX connected mode discontinuous reception
CMOS complementary metal-oxide semiconductor
CN core network
cRAN cloud radio access network
CSI channel state information
CU central unit
D2D device-to-device
DCI downlink control information
DCP DCI with CRC scrambled by PS-RNTI
DRX discontinuous reception
DU distributed unit
eDRX extended discontinuous reception
eMBB enhanced mobile broadband
eMTC enhanced machine type communication
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
I/F interface
IoT Internet of Things
L1 layer 1
LTE long term evolution
MAC medium access control
MME mobility management entity
NB-IoT narrow band Internet of Things
ng or NG new generation
ng-eNB or NG-eNB new generation eNB
NR new radio
N/W or NW network
OFDM orthogonal frequency division multiplexing
OOK on-off key
O-RAN open radio access network
PDCCH physical downlink control channel
PDCP packet data convergence protocol
PEI paging early indication
PHY physical layer
ProSe proximity service
RA registration area
RAN radio access network
RF radio frequency
RLC radio link control
RNA RAN-based notification area
RRC radio resource control
RRH remote radio head
RS reference signal
RSRP reference signal received power
RSRQ reference signal received quality
RU radio unit
Rx receiver
SDAP service data adaptation protocol
SGW serving gateway
SI system information
SIB system information block
SL sidelink
SMF session management function
SS synchronization signal
SSB synchronization signal block
Tx transmitter
UE user equipment (e.g., a wireless, typically mobile device)
UPF user plane function
V2I vehicle to infrastructure
V2P vehicle to pedestrians
V2N vehicle to network
V2V vehicle to vehicle
V2X vehicle-to-everything
VNR virtualized network function
WUR ware-up receiver
WUS wake-up signal
ZC Zadoff Chu

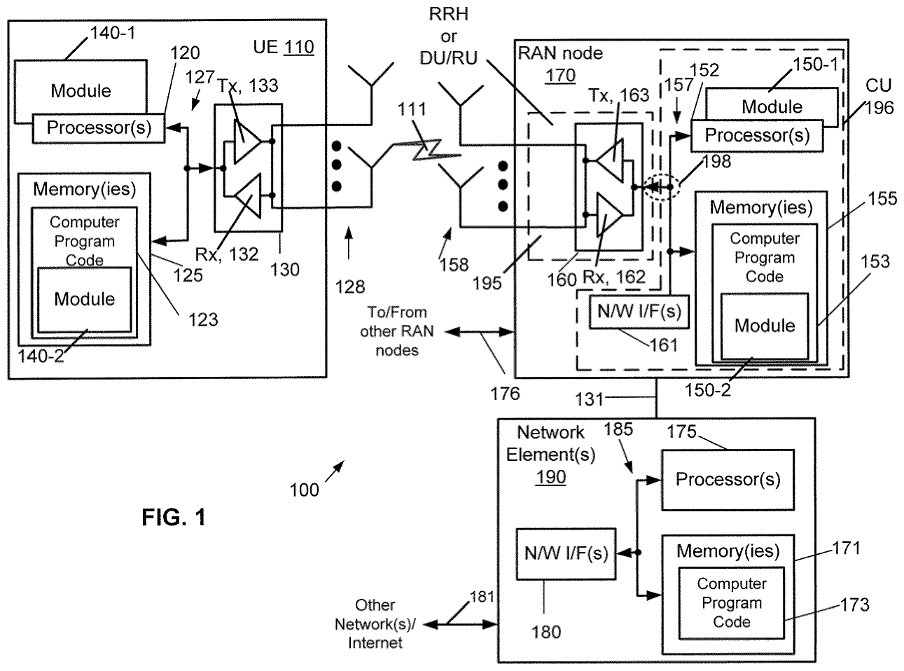

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more transceivers 130 may comprise, at least, a low-power wake-up receiver and a main receiver. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The UE 110 may be capable of sidelink communication with other UEs in addition to network communication or if wireless communication with a network is unavailable or not possible. For example, the UE 110 may perform sidelink communication with another UE which may include some or all of the features of UE 110, and/or may include additional features. Optionally, the UE 110 may also communicate with other UEs via short range communication technologies, such as Bluetooth®.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions. In addition, various embodiments of the user equipment 110 can include, but are not limited to, devices integrated into vehicles, infrastructure associated with vehicular travel, wearable devices used by pedestrians or other non-vehicular users of roads, user equipment unrelated to traffic users, and user equipment configured to participate in sidelink scenarios, such as public safety user equipment and/or other commercial user equipment.

Having thus introduced one suitable but non-limiting technical context for the practice of the example embodiments of the present disclosure, example embodiments will now be described with greater specificity.

Features as described herein generally relate to enhancements for UE energy savings in 5G NR. More specifically, features as described herein generally relate to UEs/devices which have battery life time targets of weeks or even years. For example, features as described herein may relate to devices without a continuous energy source, for example UEs that use small rechargeable or non-rechargeable single coin cell batteries, such as those used for vertical use cases (e.g. including sensors and actuators that are deployed extensively for monitoring, measuring, charging, etc.). Generally, their batteries are not rechargeable and are expected to last at least a few years, as described in TR 38.875. Additionally, features as described herein may relate to wearables, such as smart watches, rings, eHealth related devices, industrial IoT devices, and/or medical monitoring devices, for which it is challenging to sustain up to 1-2 weeks, as required, with typical battery capacity.

Some of the UE types named above (e.g. sensors, actuators, wearables, etc.) not only require a long battery life, but also require latency-critical services (e.g. sensors for fire detection and extinguishing). Therefore, solutions such as extended discontinuous reception (eDRX) (i.e. allowing extension of the periodicity by which the UE wakes up to monitor for paging, which in turn reduces the average power consumption), may not be applicable, as eDRX would lead to unacceptable communication latency.

Additionally or alternatively, example embodiments of the present disclosure may be applicable to sidelink UEs, for example in a scenario in which a network or cell switches off/on for a UE configured to perform sidelink (SL) operations. NR SL methods may be implemented to provide communication between a vehicle and a network, infrastructure(s), other vehicle (s), or other road user(s) in the surrounding/immediate area. Such communication may enable proximity service (ProSe), or transmission of information about the surrounding environment, between devices in close proximity, for example device-to-device (D2D) communication technology. Such direct communication may be available even when network coverage is unavailable. Additionally or alternatively, NR SL methods may relate to Internet of Things (IoT) and automotive industries (e.g., for reduction of accident risk and safer driving experiences). These use cases may include a message exchange among vehicles (V2V), vehicles and pedestrians (V2P), vehicles and infrastructure (V2I), and/or vehicles and networks (V2N), and may be referred to as vehicle-to-everything (V2X). The allocation of V2V resources in cellular, i.e., time and frequency resources, can be either controlled by the cellular network structure or performed autonomously by the individual vehicles (e.g. UE devices thereof). Sidelink may use same or different carrier frequencies or frequency bands than cellular communication.

A new Rel. 18 study on low-power Wake-Up Signal (study item RP-213645) has recently been approved to enable further UE power saving, for example for the above mentioned device types, and includes the objectives listed below:
“ . . . Identify evaluation methodology (including the use cases) & KPIS [RAN1]
   Primarily target low-power WUS/WUR for power-sensitive, small form-factor devices including IoT use cases (such as industrial sensors, controllers) and wearables
      Other use cases are not precluded
Study and evaluate low-power wake-up receiver architectures [RAN1, RAN4]
Study and evaluate wake-up signal designs to support wake-up receivers [RAN1, RAN4]
Study and evaluate L1 procedures and higher layer protocol changes needed to support the wake-up signals [RAN2, RAN1]
Study potential UE power saving gains compared to the existing Rel-15/16/17 UE power saving mechanisms and their coverage availability, as well as latency impact. System impact, such as network power consumption, coexistence with non-low-power-WUR UEs, network coverage/capacity/resource overhead should be included in the study [RAN1]
   Note: The need for RAN2 evaluation will be triggered by RAN1 when necessary . . . ”

A technical effect of example embodiments of the present disclosure may be to address the objective related to L1 procedures and higher layer protocol changes supporting wake-up signals, for example with respect to procedural changes for supporting the wake-up signal (WUS).

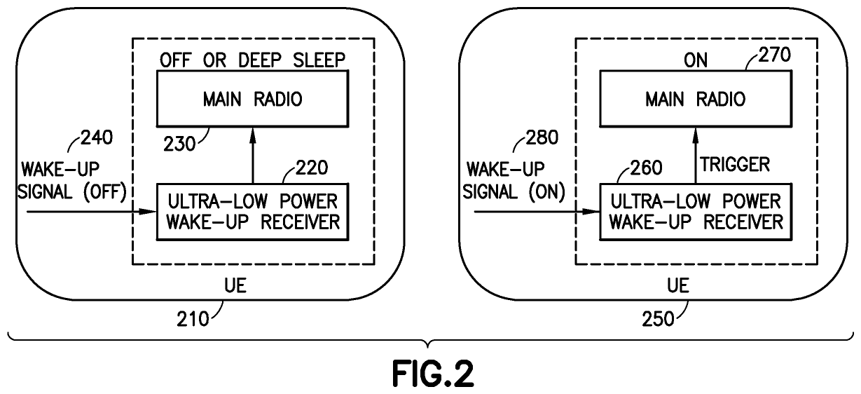

The study [RP-213645] will consider the usage of a separate low-power wake-up receiver at the UE, and evaluate how that usage may reduce the UE power consumption. The intention is that the main radio of the UE may be in a sleep mode (or even powered off) for power saving, and be activated only upon the reception of the wake-up signal from the network. Basically, the network may trigger the UE to wake-up exactly when needed in an event-driven manner, by transmitting a special WUS to the UE, which is monitored by the dedicated low-power WUS receiver at the UE. When a UE receives the WUS, the WUS receiver may trigger the wake-up of the ordinary NR transceiver, and communication may start. Thus, the ultra-low power receiver (i.e. WUS receiver) may wake up the main radio; otherwise, the main radio may be OFF or kept in a (deep) sleep mode, as shown in FIG. 2, which illustrates an example of UE operations with use of a low-power wake-up receiver (WUR). For example, a UE (210) may be OFF or in a sleep mode (e.g. RRC_IDLE, RRC_INACTIVE). A wake-up signal (240) may be received by an ultra-low power wake-up receiver (220). The ultra-low power wake-up receiver (220) may cause the main radio (230) to turn on in response to the received wake-up signal (240). A UE (250) may be in an ON mode (e.g. RRC_CONNECTED). A wake-up signal (280) may be received by an ultra-low power wake-up receiver (260). The ultra-low power wake-up receiver (260) may trigger the main radio (270) to remain on.

The assumption may be that the low-power wake-up receiver can be operated in an always ‘on’ manner with very low power consumption. In fact, it may be expected that the WUR may consume significantly less power compared to the NR transceiver, by designing a simple (WUS) signal and the use of dedicated hardware for its monitoring, which may only be able to receive the WUS.

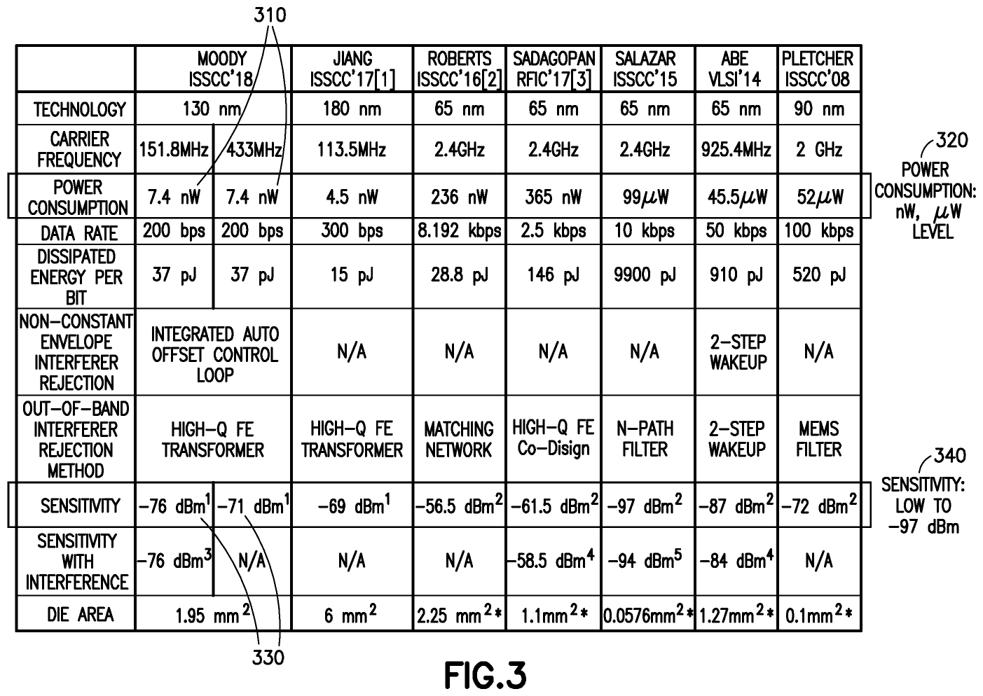

It may be noted that there is a tradeoff between the power consumption and RF sensitivity (coverage) of a WUS receiver, and that the WUS receiver sensitivity is usually significantly worse than the main (e.g. LTE/WIFI) receiver. For example, according to RWS-210168, for a main receiver in NR idle, RF sensitivity-100 dBm is associated with an average power consumption of 30-50 mw. Typically, the NR receiver can operate at around −100 dBm. In contrast, for a low power WUS receiver (i.e. almost zero power receiver using a passive circuit with envelope detector), RF sensitivity ˜−70/80 dBm with an average power consumption of 7.4 nW. This means 100× power saving, with some sensitivity degradation. Further examples of the tradeoff for almost zero-power receivers (using a CMOS RF front-end with on-off-key, OOK, energy detection) are shown in FIG. 3. In the power consumption row (320), at 310 power consumption of 7.4 nw is shown for Moody ISSCC '18. In the sensitivity row (340), at 330 sensitivity of −76 dBm and −71 dBm is shown for Moody ISSCC '18.

The cell size (coverage area) will differ for the low-power WUS and legacy DCI-based paging. Specifically, the WUS coverage area will typically be smaller than the entire cell area in which legacy DCI-based paging is supported. This is due to the smaller WUS receiver sensitivity, and furthermore due to use of different modulation/coding and potentially different carrier frequencies for the WUS compared to the legacy paging. A technical effect of example embodiments of the present disclosure may be to address this difference in UE receiver sensitivity and/or cell coverage area.

In legacy DCI-based paging, the DCI indicates the presence of a paging, and scheduling information of the paging. In other words, the DCI may indicate that a paging will be transmitted at radio resources indicated in the scheduling information.

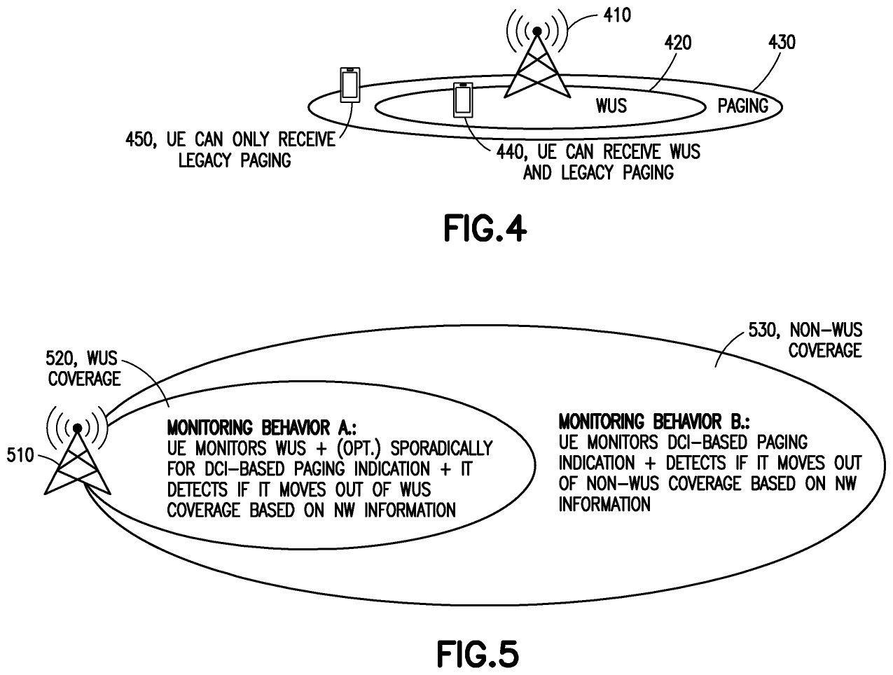

Referring now to FIG. 4, illustrated is an example in which the radio coverage area of WUS (420) is different (i.e. smaller) than the radio coverage area of legacy paging (430). In the example of FIG. 4, the radio coverage area of legacy paging (430) encompasses, at least, the radio coverage area of WUS (420) and additional area. A UE (450) near the cell edge may only be able to receive legacy paging (430), while a UE (440) closer to the cell center (410) may be able to receive both WUS (420) and legacy paging (430).

In the present disclosure, the terms “coverage area” and “radio coverage area” may be used interchangeably to denote an area where a signal can be received above a certain threshold/quality by the UE. The coverage area may have any shape, and may be shorter/smaller in some directions than in others. This may be a function of a characteristic of the transmitter, a characteristic of the receiver, and/or a characteristic of the environment. For example, even if a UE is close to a base station, it may be blocked by an obstacle such that the UE is outside the radio coverage area of WUS. In such a scenario, the UE may not be able to receive the WUS, but only DCI-based paging.

It may be noted that the coverage area of the WUS (420) may be the coverage area of a WUS or a WUS beacon. A WUS is used to wake-up one UE or a group of UEs such that they are able to monitor DCI-based paging. The WUS may be dedicated to that/those UEs, for example in terms of dedicated resources in time/frequency domain(s) or by use of a specific signal sequence/scrambling ID. A WUS beacon is used by any UE which is monitoring the dedicated WUS to determine whether they are still within the radio coverage. Thus, it may be a signal known to all UEs in terms of resources/sequence/scrambling, as the UEs may not necessarily determine radio coverage based on the WUS, which is only transmitted if the UE(s) has to monitor DCI-based paging. If there is a long period without paging, the WUS may not be transmitted and the UE may not know if it is still in WUS coverage or not. However, by always transmitting the WUS beacon, the UE may be enabled to continue to monitor its WUS coverage status.

In a cell where both mechanisms (WUS and DCI-based paging) coexist, a UE may be able to determine whether it is located in an area in the cell where it is capable to receive WUS, in which case the UE may monitor WUS in order to save energy. Otherwise, if the UE is unable to receive WUS, the UE may monitor regular paging in order to be reachable, despite the higher power consumption, since if the UE monitors for WUS, but it is unable to receive WUS, then paging will fail. In an example embodiment of the present disclosure, the UE may be able to determine whether to monitor WUS or regular paging based on a network configuration.

In an example embodiment of the present disclosure, a UE may be enabled to handle such co-existence of low-power WUS and non-WUS operations in a cell, and to determine appropriately when to monitor for WUS and when not. Note that we assume that the network would always transmit both the WUS and legacy paging to avoid unreachability of the UE and unnecessary resource/energy cost for paging escalation at the network side; this assumption is as in WUS for NB-IoT.

RWS-210168 raised the problem of ensuring UE reachability, noting that an event, such as a keep alive signal, may be sent to a UE, which may trigger regular idle mode of the UE. Based on network/UE two-way confirmation, the UE may enter an almost-zero-power mode. In this mode, the UE may still be able to receive a keep-alive signal, such as WUS.

In LTE eMTC and NB-IoT release 15, the WUS was defined for Idle mode paging monitoring. The LTE WUS may be a Zadoff Chu sequence-based signal. Both the WUS and PDCCH-based paging may be received with a same, ordinary receiver. Such WUS may always be transmitted to avoid UE unreachability.

Rel.16 DCI-based WUS in RRC Connected (DCP) is defined in 5G NR to control whether the UE should wake-up to monitor for the C-DRX On-Duration (see e.g. TS 38.331 and TS 38.213).

Rel-17 DCI-based WUS in RRC Idle/Inactive (Paging Early Indication, PEI) is defined in 5G NR to control whether the UE should wake-up to monitor for the DCI-based paging (see e.g. TS 38.331 and TS 38.304).

In an example embodiment, a UE supporting low-power wake-up signal monitoring may determine whether to monitor for WUS or DCI-based paging indications based on whether the UE is in WUS coverage or not (i.e. outside WUS coverage). In an example embodiment, WUS coverage (or out-of-WUS coverage) may be determined based on NW information (e.g. rules and/or parameters). In an example embodiment, specific monitoring behaviors for the UE may be implemented for the cases when the UE is in WUS coverage, and not in WUS coverage, respectively.

In a first example embodiment, the UE supporting WUS may be configured via RRC signaling (e.g. RRC Release/SIB) with a WUS configuration, including NW information for the UE to determine the (non-)WUS coverage. In an example embodiment, the network may be configured to define these rules/thresholds based on, for example, network conditions and the reception sensitivity of a given UE.

In an example embodiment, the NW information for the UE to determine the WUS coverage may include a rule(s) and/or parameter(s) defining WUS coverage. The parameters may be set cell-wise, and may include a WUS threshold and/or a WUS beacon threshold. Additionally or alternatively, the NW information for the UE to determine the WUS coverage may include a rule(s) and/or parameter(s) defining non-WUS coverage. The parameter(s) may be set cell-wise and may include an SSB-based RSRP and/or RSRQ threshold. Additionally or alternatively, the NW information for the UE to determine the WUS coverage may include radio conditions where the UE may or may not use/be able to monitor WUS. Such radio conditions may be related, at least, to one of a signal power/quality of NR (e.g. SSB), or WUS, or WUS beacon; each of these signals may be monitored and/or measured by the UE. In one example, the UE may monitor WUS when signal power/quality of NR or WUS, or the WUS beacon, is good enough (e.g. better than a threshold). Additionally or alternatively, measurement of received power besides RSRP, and a corresponding threshold, may be used. In other words, determination of whether a UE is in a WUS or non-WUS coverage area, or whether to change monitoring behavior, may be based on a measurement of received power of a signal other than the WUS, including but not limited to a reference signal.

In an example embodiment, the NW may set the NW information (e.g. parameters such as thresholds) to be UE-specific based on any of the following: UE location (in terms of channel condition, radio signal strength) and/or UE-specific WUS receiver performance. The UE-specific WUS receiver performance may be as acquired by the network based on a minimum Rx level defined in UE capability. For example, the UE-specific parameter may be an offset to the minimum Rx level (e.g. x dB better than a minimum Rx level defined in UE capability). It may be noted that 3GPP defined test cases may ensure compliance with the minimum Rx level. Additionally or alternatively, the UE-specific WUS receiver performance may be based on UE assistance information related to its WUS RF sensitivity; the NW may use this assistance information to help define, for example, the RSRP/RSRQ threshold(s) for determining coverage area, and so the monitoring behavior a UE should employ. The WUR sensitivity determination may involve a UE-based offset to apply to an RSRP-threshold based on the WUS RF sensitivity level it supports. Additionally or alternatively, the UE assistance information may include an indication of the location of the UE within one or more coverage areas.

In an example embodiment, the NW information may depend on the last serving beam of the UE when in RRC_CONNECTED mode. In an example embodiment, the NW information may be per beam; the UE may accordingly perform monitoring using NW information related to the beam the UE used while being in an RRC_CONNECTED mode.

In a second example embodiment, a UE may determine whether to monitor WUS or DCI-based paging based on the received WUS configuration, which may assist the UE in determining whether it is, or it remains in, (non-)WUS coverage.

Referring now to FIG. 5, illustrated is an example of UE monitoring behaviors based on whether it is in “WUS coverage” (520) or in “non-WUS coverage” (530). The coverage of the UE may or may not be determined based on the distance between the UE and a base station or other network device (510), and/or based on network conditions, and/or based on a sensitivity of the UE WUR. When the UE is in “WUS coverage” (520), it may perform monitoring behavior “A”: UE may monitor WUS and, optionally, may sporadically monitor for DCI-based paging indication(s). The UE may also detect if it moves out of “WUS coverage” (520) based on NW information. When the UE is in “non-WUS coverage” (530), it may perform monitoring behavior “B”: the UE may monitor DCI-based paging indication and may detect if it moves out of “non-WUS coverage” (530) based on NW information. It may be noted that the example of FIG. 5 is not limiting; the size of the coverage areas and/or their relationship to each other, and/or to the network node, may be different.

In an example embodiment, if the UE is in “WUS coverage” (520) upon moving to RRC_IDLE or RRC_INACTIVE mode, the UE may monitor only for WUS, or the UE may monitor for WUS and, more sparsely in time, for paging DCI (i.e. less frequently compared to regular paging periodicity). The sparse monitoring for paging DCI may be done according to a second paging periodicity (e.g. defined/configured by the network), which may be larger than the legacy paging periodicity (i.e. less frequent monitoring). The UE may check regularly if it moves out of the WUS coverage based on the NW information (i.e. rule/parameters). This coverage check may be performed based on comparing a received WUS-beacon with a threshold, or just based on the presence of the WUS-beacon. If the UE detects that it has moved out of WUS coverage, it may switch on the main Rx and apply monitoring behavior for when the UE is in “non-WUS coverage,” further discussed below. During sparse monitoring for paging DCI, the coverage check may be based on SSB-based RSRP measurement(s) and corresponding threshold(s). The UE may take into account the offset between a WUS-beacon RSRP and an SSB-based RSRP (i.e. in the case that both signals are received by the UE). For example, the UE may compare a latest WUS beam received power/received level with a current SSB-based RSRP (which may be received less frequently). The UE may switch back to legacy paging based on: failing to receive the WUS beacon; a WUS counter (e.g. after certain number of (consecutive) failed WUS reception attempt(s)); and/or meeting a WUS beacon threshold(s) and/or RSRP threshold(s).

In an example embodiment, if the UE is in “non-WUS coverage” (530) upon moving to RRC_IDLE mode or RRC_INACTIVE mode (i.e. sleep mode), the UE may monitor only for the regular paging DCI. The UE may check regularly whether it moves out of non-WUS coverage (moves in WUS-coverage) based on rule/parameters (e.g. meeting a RSRP/RSRQ threshold may trigger monitoring for a WUS-beacon) and may switch to behavior for when the UE is in “WUS coverage” if it detects the WUS beacon. The UE may monitor infrequently for WUS and when it detects WUS, it may switch back to WUS monitoring. Optionally, more rules may be defined (e.g. WUS received power/received level may need to be more than a threshold, or more than a certain number of consecutive successful WUS receptions). In an example, the UE may have to take into account how often the UE is paged for deciding whether to switch WUS monitoring behavior. For example, if it is frequently paged, there may be no big gain in switching to WUS, because the UE may often need to power on the main transceiver anyway.

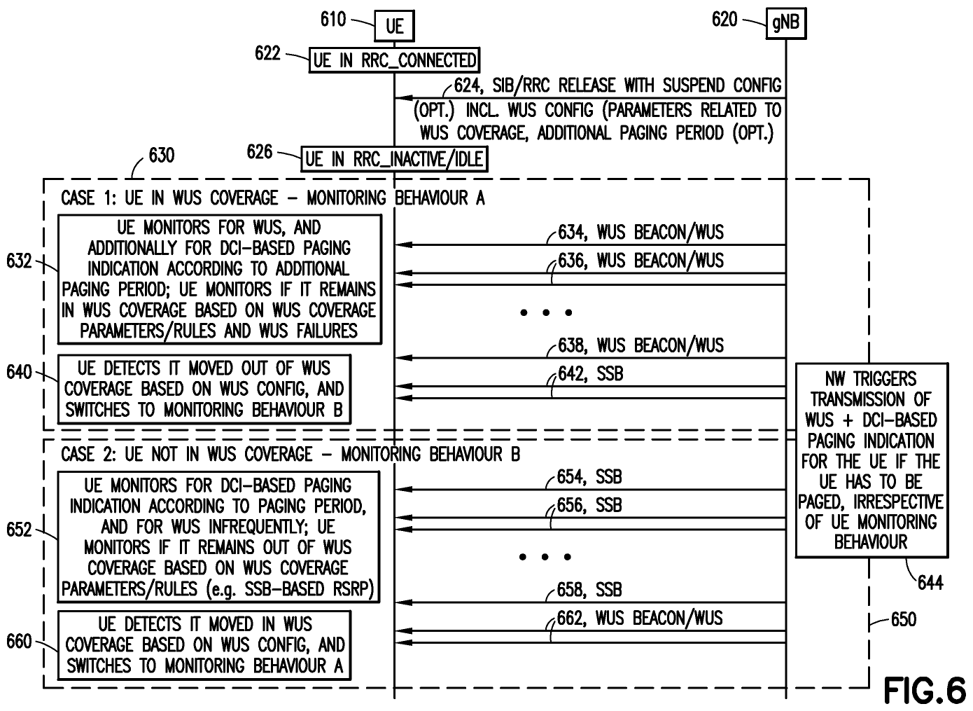

Referring now to FIG. 6, illustrated is a signaling flow chart between a UE (610) and a gNB (620). The UE (610) may perform monitoring behavior according to example embodiments of the present disclosure. It may be noted that the paging from the network side (e.g. transmission of WUS, followed by DCI-based paging) is not illustrated in FIG. 6. In an example embodiment, if the UE receives paging, it may respond to the paging as in a legacy procedure.

At 622, the UE may be in an RRC_CONNECTED mode/state. At 624, the UE (610) may receive, from the gNB (620), a system information block (SIB) and/or a radio resource control (RRC) release with suspend configuration (optional). The RRC release message may be dedicated signaling for delivery of network information. The SIB and/or RRC release may include a WUS configuration. For example, the WUS configuration may include network information, such as rules/parameters related to WUS coverage. Optionally, the WUS configuration may include additional paging period information, such as periodicity for monitoring WUS and a periodicity of monitoring DCI-based paging during each of monitoring behaviors “A” and “B”. At 626, the UE may enter an RRC_INACTIVE mode, an RRC_IDLE mode, or a sleep mode.

In a first case, the UE (610) may be in WUS coverage, and may perform monitoring behavior “A” (630). At 632, the UE may monitor for WUS, and may additionally monitor for DCI-based paging indication, according to an additional paging period information (e.g. a less frequent/longer periodicity than for WUS monitoring). The monitoring may be performed with a low-power wake-up receiver/transceiver. The UE may monitor if it remains in WUS coverage based on WUS coverage parameters/rules and/or WUS failures. At 634, 636, and 638, the UE (610) may detect a WUS beacon/WUS. While FIG. 6 illustrates detection of three WUS beacon/WUS, a smaller or greater number of WUS beacon/WUS may be detected by the UE (610). At 640, the UE may detect that it has moved out of WUS coverage based on the WUS configuration, and may switch to monitoring behavior “B”. For example, the WUS detected at 638 may not meet a threshold, which may trigger the switch in monitoring behavior. For example, the UE may determine that a power/level of a received WUS or WUS beacon is below a threshold value. For example, the UE may determine that a quality of a received WUS or WUS beacon is below a threshold value. For example, the UE may determine that a RSRP of a SSB is below a threshold value. At 642, the UE (610) may detect SSB after having transitioned to monitoring behavior “B”.

At 644, the NW may trigger transmission of WUS and DCI-based paging indication for the UE (610) if the UE (610) has to be paged, irrespective of UE monitoring behavior. This may occur in case 1 (630) and/or case 2 (650).

In a second case, the UE (610) may not be in WUS coverage (e.g. may be outside WUS coverage), and may perform monitoring behavior “B” (650). At 652, the UE may monitor for DCI-based paging indication according to a paging period, and may infrequently (i.e. less frequently) monitor for WUS (e.g. according to additional paging period information). The monitoring may be performed with a main receiver/transceiver. The UE may monitor if it remains out of WUS coverage based on WUS coverage parameters/rules (e.g. SSB-based RSRP, or WUS received power/level). At 654, 656, and 658, the UE may detect SSB. While FIG. 6 illustrates detection of three SSB, a smaller greater number of SSB may be detected by the UE (610). At 660, the UE may detect that it moved into WUS coverage based on a WUS configuration, and may switch to monitoring behavior “A”. For example, the UE may determine that a power/level of a received WUS or WUS beacon meets or exceeds a threshold value. For example, the UE may determine that a quality of a received WUS or WUS beacon meets or exceeds a threshold value. For example, a UE may determine that a RSRP of a SSB meets or exceeds a threshold value. At 662, the UE (610) may detect a WUS beacon/WUS after having transitioned to monitoring behavior “A”.

It should be noted that, in FIG. 6, each of case 1 (630) and case 2 (650) is optional; the UE may experience the cases in a different order, or may experience only one of the cases. The sequence illustrated in FIG. 6 is not limiting.

A technical effect of example embodiments of the present disclosure may be to allow a network controlled mechanism for when the UE should perform WUS monitoring in the cell. A technical effect of example embodiments of the present disclosure may be to enable a tradeoff between UE energy saving (which increases if UE monitors WUS rather than DCI-based paging) and UE reachability (if UE monitors WUS when cannot detect WUS, the UE becomes not reachable, which leads to undesired paging escalation at the network side).

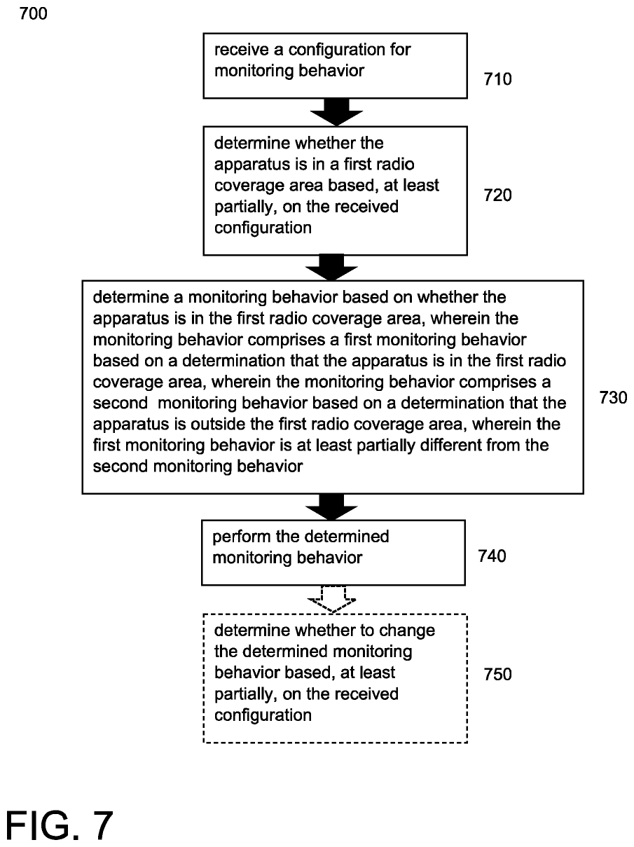

FIG. 7 illustrates the potential steps of an example method 700. The example method 700 may include: receiving a configuration for monitoring behavior, 710; determining whether the apparatus is in a first radio coverage area based, at least partially, on the received configuration, 720; determining a monitoring behavior based on whether the apparatus is in the first radio coverage area, wherein the monitoring behavior comprises a first monitoring behavior based on a determination that the apparatus s in the first radio coverage area, wherein the monitoring behavior comprises a second monitoring behavior based on a determination that the apparatus is outside the first radio coverage area, wherein the first monitoring behavior is at least partially different from the second monitoring behavior, 730; and performing the determined monitoring behavior, 740. Optionally, the example method 700 may include: determining whether to change the determined monitoring behavior based, at least partially, on the received configuration, 750. The example method 700 may be performed, for example, by a user equipment.

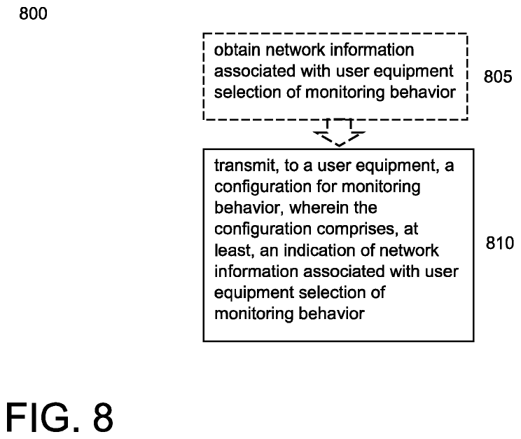

FIG. 8 illustrates the potential steps of an example method 800. The example method 800 may include: transmitting, to a user equipment, a configuration for monitoring behavior, wherein the configuration comprises, at least, an indication of network information associated with user equipment selection of monitoring behavior, 810. The example method 800 may be performed, for example, by a network entity, such as a base station, eNB, gNB, etc. The example method 800 may optionally include obtaining the network information, 805.

In accordance with one example embodiment, an apparatus may comprise: at least one processor; and at least one memory storing instructions that, when executed by the at least one processor, cause the apparatus at least to: receive a configuration for monitoring behavior; determine whether the apparatus is in a first radio coverage area based, at least partially, on the received configuration; determine a monitoring behavior based on whether the apparatus is in the first radio coverage area, wherein the monitoring behavior may comprise a first monitoring behavior based on a determination that the apparatus is in the first radio coverage area, wherein the monitoring behavior may comprise a second monitoring behavior based on a determination that the apparatus is outside the first radio coverage area, wherein the first monitoring behavior may be at least partially different from the second monitoring behavior; and perform the determined monitoring behavior.

The configuration for monitoring behavior may comprise an indication of at least one of: at least one rule defining the first radio coverage area, at least one parameter defining the first radio coverage area, at least one threshold value associated with a wake-up signal, at least one threshold value associated with a wake-up signal beacon, at least one rule defining a second radio coverage area, wherein the second radio coverage area may be at least partially different from the first radio coverage area, at least one parameter defining the second radio coverage area, at least one threshold value associated with a synchronization signal block-based reference signal received power, at least one threshold value associated with a synchronization signal block-based reference signal received quality, at least one radio condition for wake-up signal monitoring, at least one radio condition for wake-up signal beacon monitoring, at least one radio condition for downlink control information based paging monitoring, at least one radio condition associated with a signal power of a downlink control information paging signal, at least one radio condition associated with a signal quality of the downlink control information paging signal, at least one radio condition associated with a signal power of a wake-up signal, at least one radio condition associated with a signal quality of a wake-up signal, at least one radio condition associated with a signal power of a wake-up signal beacon, or at least one radio condition associated with a signal quality of a wake-up signal beacon.

The example apparatus may be further configured to: determine whether to change the determined monitoring behavior based, at least partially, on the received configuration.

The determined monitoring behavior may comprise the first monitoring behavior, wherein determining whether to change the determined monitoring behavior may comprise the example apparatus being further configured to: determine that the apparatus has moved outside the first radio coverage area based on at least one of: a determination that a number of failed attempts to receive a wake-up signal or wake-up signal beacon meets or exceeds a predetermined number, a determination that a power of at least one received wake-up signal or at least one wake-up signal beacon is below at least one first threshold value, a determination that a quality of the at least one received wake-up signal or the at least one wake-up signal beacon is below at least one second threshold value, or a determination that a reference signal received power measurement of at least one synchronization signal block is below at least one third threshold value; determine to change the determined monitoring behavior to the second monitoring behavior in response to the determination that the apparatus has moved outside the first radio coverage area; and perform the second monitoring behavior, wherein the received configuration may comprise at least one of: an indication of the predetermined number, an indication of the at least one first threshold value, an indication of the at least one second threshold value, or an indication of the at least one third threshold value.

The determined monitoring behavior may comprise the first monitoring behavior, performing the determined monitoring behavior may comprise the example apparatus being further configured to: monitor for a wake-up signal or a wake-up beacon with a first periodicity.

The example apparatus may be further configured to: monitor for downlink control information based paging with a second periodicity, wherein the second periodicity may be longer than the first periodicity.

The determined monitoring behavior may comprise the second monitoring behavior, wherein determining whether to change the determined monitoring behavior comprises may comprise the example apparatus being further configured to: determine that that the apparatus has moved within the first radio coverage area based on at least one of: a determination that a wake-up signal or a wake-up signal beacon has been detected, a determination that a power of at least one received wake-up signal or at least one received wake-up signal beacon meets or exceeds at least one first threshold value, a determination that a quality of the at least one received wake-up signal or the at least one received wake-up signal beacon meets or exceeds at least one second threshold value, or a determination that a reference signal received power measurement of at least one synchronization signal block meets or exceeds at least one third threshold value; determine to change the determined monitoring behavior to the first monitoring behavior in response to the determination that the apparatus has moved within the first radio coverage area; and perform the first monitoring behavior, wherein the received configuration may comprise at least one of: an indication of the at least one first threshold value, an indication of the at least one second threshold value, or an indication of the at least one third threshold value.

The determined monitoring behavior may comprise the second monitoring behavior, wherein performing the determined monitoring behavior comprises may comprise the example apparatus being further configured to: monitor for downlink control information based paging with a first periodicity.

The example apparatus may be further configured to: monitor for a wake-up signal or a wake-up beacon with a second periodicity, wherein the second periodicity may be longer than the first periodicity.

The example apparatus may be further configured to: operate in at least one of: a radio resource control inactive mode, a radio resource control idle mode, or a sleep mode.

Determining whether the apparatus is in the first radio coverage area may comprise the example apparatus being further configured to: perform at least one measurement; compare the at least one measurement to at least one threshold, wherein the received configuration may comprise, at least, an indication of the at least one threshold; and determine whether the apparatus is in the first radio coverage area based on a result of the comparing.

The example apparatus may be further configured to: transmit, to a network, assistance information, wherein the assistance information may comprise an indication of at least one of: a minimum wake-up signal or wake-up signal beacon received power level, a minimum wake-up signal or wake-up signal beacon received power sensitivity, a location of the apparatus with respect to the first radio coverage area, a minimum receiver performance of the apparatus, information associated with a wake-up signal receiver of the apparatus, a wake-up signal radio frequency sensitivity level supported by the apparatus, or a last serving beam associated with the apparatus.

In accordance with one aspect, an example method may be provided comprising: receiving, with a user equipment, a configuration for monitoring behavior; determining whether the user equipment is in a first radio coverage area based, at least partially, on the received configuration; determining a monitoring behavior based on whether the user equipment is in the first radio coverage area, wherein the monitoring behavior may comprise a first monitoring behavior based on a determination that the user equipment is in the first radio coverage area, wherein the monitoring behavior may comprise a second monitoring behavior based on a determination that the user equipment is outside the first radio coverage area, wherein the first monitoring behavior may be at least partially different from the second monitoring behavior; and performing, with the user equipment, the determined monitoring behavior.

The configuration for monitoring behavior may comprise an indication of at least one of: at least one rule defining the first radio coverage area, at least one parameter defining the first radio coverage area, at least one threshold value associated with a wake-up signal, at least one threshold value associated with a wake-up signal beacon, at least one rule defining a second radio coverage area, wherein the second radio coverage area may be at least partially different from the first radio coverage area, at least one parameter defining the second radio coverage area, at least one threshold value associated with a synchronization signal block-based reference signal received power, at least one threshold value associated with a synchronization signal block-based reference signal received quality, at least one radio condition for wake-up signal monitoring, at least one radio condition for wake-up signal beacon monitoring, at least one radio condition for downlink control information based paging monitoring, at least one radio condition associated with a signal power of a downlink control information paging signal, at least one radio condition associated with a signal quality of the downlink control information paging signal, at least one radio condition associated with a signal power of a wake-up signal, at least one radio condition associated with a signal quality of a wake-up signal, at least one radio condition associated with a signal power of a wake-up signal beacon, or at least one radio condition associated with a signal quality of a wake-up signal beacon.

The example method may further comprise: determining whether to change the determined monitoring behavior based, at least partially, on the received configuration.

The determined monitoring behavior may comprise the first monitoring behavior, wherein the determining of whether to change the determined monitoring behavior may comprise: determining that the user equipment has moved outside the first radio coverage area based on at least one of: a determination that a number of failed attempts to receive a wake-up signal or wake-up signal beacon meets or exceeds a predetermined number, a determination that a power of at least one received wake-up signal or at least one wake-up signal beacon is below at least one first threshold value, a determination that a quality of the at least one received wake-up signal or the at least one wake-up signal beacon is below at least one second threshold value, or a determination that a reference signal received power measurement of at least one synchronization signal block is below at least one third threshold value; determining to change the determined monitoring behavior to the second monitoring behavior in response to the determination that the user equipment has moved outside the first radio coverage area; and performing the second monitoring behavior, wherein the received configuration may comprise at least one of: an indication of the predetermined number, an indication of the at least one first threshold value, an indication of the at least one second threshold value, or an indication of the at least one third threshold value.

The determined monitoring behavior may comprise the first monitoring behavior, wherein the performing of the determined monitoring behavior may comprise: monitoring for a wake-up signal or a wake-up beacon with a first periodicity.

The example method may further comprise: monitoring for downlink control information based paging with second periodicity, wherein the second periodicity may be longer than the first periodicity.

The determined monitoring behavior may comprise the second monitoring behavior, wherein the determining of whether to change the determined monitoring behavior may comprise: determining that that the user equipment has moved within the first radio coverage area based on at least one of: a determination that a wake-up signal or a wake-up signal beacon has been detected, a determination that a power of at least one received wake-up signal or at least one received wake-up signal beacon meets or exceeds at least one first threshold value, a determination that a quality of the at least one received wake-up signal or the at least one received wake-up signal beacon meets or exceeds at least one second threshold value, or a determination that a reference signal received power measurement of at least one synchronization signal block meets or exceeds at least one third threshold value; determining to change the determined monitoring behavior to the first monitoring behavior in response to the determination that the user equipment has moved within the first radio coverage area; and performing the first monitoring behavior, wherein the received configuration may comprise at least one of: an indication of the at least one first threshold value, an indication of the at least one second threshold value, or an indication of the at least one third threshold value.

The determined monitoring behavior may comprise the second monitoring behavior, wherein the performing of the determined monitoring behavior may comprise: monitoring for downlink control information based paging with a first periodicity.

The example method may further comprise: monitoring for a wake-up signal or a wake-up beacon with a second periodicity, wherein the second periodicity may be longer than the first periodicity.

The example method may further comprise: operating in at least one of: a radio resource control inactive mode, a radio resource control idle mode, or a sleep mode.

The determining of whether the user equipment is in the first radio coverage area may comprise: performing at least one measurement; comparing the at least one measurement to at least one threshold, wherein the received configuration may comprise, at least, an indication of the at least one threshold; and determining whether the user equipment is in the first radio coverage area based on a result of the comparing.

The example method may further comprise: transmitting, to a network, assistance information, wherein the assistance information may comprise an indication of at least one of: a minimum wake-up signal or wake-up signal beacon received power level, a minimum wake-up signal or wake-up signal beacon received power sensitivity, a location 44 the user equipment with respect to the first radio coverage area, a minimum receiver performance of the user equipment, information associated with a wake-up signal receiver of the user equipment, a wake-up signal radio frequency sensitivity level supported by the user equipment, or a last serving beam associated with the user equipment.

In accordance with one example embodiment, an apparatus may comprise: circuitry configured to perform: receiving, with a user equipment, a configuration for monitoring behavior; circuitry configured to perform: determining whether the user equipment is in a first radio coverage area based, at least partially, on the received configuration; circuitry configured to perform: determining a monitoring behavior based on whether the user equipment is in the first radio coverage area, wherein the monitoring behavior may comprise a first monitoring behavior based on a determination that the user equipment is in the first radio coverage area, wherein the monitoring behavior may comprise a second monitoring behavior based on a determination that the user equipment is outside the first radio coverage area, wherein the first monitoring behavior may be at least partially different from the second monitoring behavior; and circuitry configured to perform: with the user equipment, the determined monitoring behavior.

In accordance with one example embodiment, an apparatus may comprise: processing circuitry; memory circuitry including computer program code, the memory circuitry and the computer program code configured to, with the processing circuitry, enable the apparatus to: receive a configuration for monitoring behavior; determine whether the apparatus is in a first radio coverage area based, at least partially, on the received configuration; determine a monitoring behavior based on whether the apparatus is in the first radio coverage area, wherein the monitoring behavior may comprise a first monitoring behavior based on a determination that the apparatus is in the first radio coverage area, wherein the monitoring behavior may comprise a second monitoring behavior based on a determination that the apparatus is outside the first radio coverage area, wherein the first monitoring behavior may be at least partially different from the second monitoring behavior; and perform the determined monitoring behavior.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation H merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: receiving a configuration for monitoring behavior; determining whether the apparatus is in a first radio coverage area based, at least partially, on the received configuration; determining a monitoring behavior based on whether the apparatus is in the first radio coverage area, wherein the monitoring behavior may comprise a first monitoring behavior based on a determination that the apparatus is in the first radio coverage area, wherein the monitoring behavior may comprise a second monitoring behavior based on a determination that the apparatus is outside the first radio coverage area, wherein the first monitoring behavior may be at least partially different from the second monitoring behavior; and causing performance of the determined monitoring behavior.

The configuration for monitoring behavior may comprise an indication of at least one of: at least one rule defining the first radio coverage area, at least one parameter defining the first radio coverage area, at least one threshold value associated with a wake-up signal, at least one threshold value associated with a wake-up signal beacon, at least one rule defining a second radio coverage area, wherein the second radio coverage area may be at least partially different from the first radio coverage area, at least one parameter defining the second radio coverage area, at least one threshold value associated with a synchronization signal block-based reference signal received power, at least one threshold value associated with a synchronization signal block-based reference signal received quality, at least one radio condition for wake-up signal monitoring, at least one radio condition for wake-up signal beacon monitoring, at least one radio condition for downlink control information £ based paging monitoring, at least one radio condition associated with a signal power of a downlink control information paging signal, at least one radio condition associated with a signal quality of the downlink control information paging signal, at least one radio condition associated with a signal power of a wake-up signal, at least one radio condition associated with a signal quality of a wake-up signal, at least one radio condition associated with a signal power of a wake-up signal beacon, or at least one radio condition associated with a signal quality of a wake-up signal beacon.

The means may be further configured to perform: determining whether to change the determined monitoring behavior based, at least partially, on the received configuration.

The determined monitoring behavior may comprise the first monitoring behavior, wherein the means configured to perform determining whether to change the determined monitoring behavior may comprise means configured to perform: determining that the apparatus has moved outside the first radio coverage area based on at least one of: a determination that a number of failed attempts to receive a wake-up signal or wake-up signal beacon meets or exceeds a predetermined number, a determination that a power of at least one received wake-up signal or at least one wake-up signal beacon is below at least one first threshold value, a determination that a quality of the at least one received wake-up signal or the at least one wake-up signal beacon is below at least one second threshold value, or a determination that a reference signal received power measurement of at least one synchronization signal block is below at least one third threshold value; determining to change the determined monitoring behavior to the second monitoring behavior in response to the determination that the apparatus has moved outside the first radio coverage area; and performing the second monitoring behavior, wherein the received configuration may comprise at least one of: an indication of the predetermined number, an indication of the at least one first threshold value, an indication of the at least one second threshold value, or an indication of the at least one third threshold value.

The determined monitoring behavior may comprise the first monitoring behavior, wherein the means configured to perform the determined monitoring behavior may comprise means configured to perform: monitoring for a wake-up signal or a wake-up beacon with a first periodicity.

The means may be further configured to perform: monitoring for downlink control information based paging with a second periodicity, wherein the second periodicity may be longer than the first periodicity.

The determined monitoring behavior may comprise the second monitoring behavior, wherein the means configured to perform determining whether to change the determined monitoring behavior may comprise means configured to perform: determining that that the apparatus has moved within the first radio coverage area based on at least one of: a determination that a wake-up signal or a wake-up signal beacon has been detected, a determination that a power of at least one received wake-up signal or at least one received wake-up signal beacon meets or exceeds at least one first threshold value, a determination that a quality of the at least one received wake-up signal or the at least one received wake-up signal beacon meets or exceeds at least one second threshold value, or a determination that a reference signal received power measurement of at least one synchronization signal block meets or exceeds at least one third threshold value; determining to change the determined monitoring behavior to the first monitoring behavior in response to the determination that the apparatus has moved within the first radio coverage area; and performing the first monitoring behavior, wherein the received configuration may comprise at least one of: an indication of the at least one first threshold value, an indication of the at least one second threshold value, or an indication of the at least one third threshold value.

The determined monitoring behavior may comprise the second monitoring behavior, wherein the means configured to perform the determined monitoring behavior may comprise means configured to perform: monitoring for downlink control information based paging with a first periodicity.

The means may be further configured to perform: monitoring for a wake-up signal or a wake-up beacon with a second periodicity, wherein the second periodicity may be longer than the first periodicity.

The means may be further configured to perform: operating in at least one of: a radio resource control inactive mode, a radio resource control idle mode, or a sleep mode.

The means configured to perform determining whether the apparatus is in the first radio coverage area may comprise means configured to perform: at least one measurement; comparing the at least one measurement to at least one threshold, wherein the received configuration may comprise, at least, an indication of the at least one threshold; and determining whether the apparatus is in the first radio coverage area based on a result of the comparing.

The means may be further configured to perform: transmitting, to a network, assistance information, wherein the assistance information may comprise an indication of at least one of: a minimum wake-up signal or wake-up signal beacon received power level, a minimum wake-up signal or wake-up signal beacon received power sensitivity, a location of the apparatus with respect to the first radio coverage area, a minimum receiver performance of the apparatus, information associated with a wake-up signal receiver of the apparatus, a wake-up signal radio frequency sensitivity level supported by the apparatus, or a last serving beam associated with the apparatus.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: cause receiving of a configuration for monitoring behavior; determine whether a user equipment is in a first radio coverage area based, at least partially, on the received configuration; determine a monitoring behavior based on whether the user equipment is in the first radio coverage area, wherein the monitoring behavior comprises a first monitoring behavior based on a determination that the user equipment is in the first radio coverage area, wherein the monitoring behavior comprises a second monitoring behavior based on a determination that the user equipment is outside the first radio coverage area, wherein the first monitoring behavior is at least partially different from the second monitoring behavior; and cause performance of the determined monitoring behavior.

In accordance with one example embodiment, a non-transitory computer-readable medium comprising program instructions stored thereon for performing at least the following: receiving a configuration for monitoring behavior; determining whether a user equipment is in a first radio coverage area based, at least partially, on the received configuration; determining a monitoring behavior based on whether the user equipment is in the first radio coverage area, wherein the monitoring behavior may comprise a first monitoring behavior based on a determination that the user equipment is in the first radio coverage area, wherein the monitoring behavior may comprise a second monitoring behavior based on a determination that the user equipment is outside the first radio coverage area, wherein the first monitoring behavior may be at least partially different from the second monitoring behavior; and causing performance of the determined monitoring behavior.

In accordance with another example embodiment, a non-transitory program storage device readable by a machine may be provided, tangibly embodying instructions executable by the machine for performing operations, the operations comprising: receiving a configuration for monitoring behavior; determining whether a user equipment is in a first radio coverage area based, at least partially, on the received configuration; determining a monitoring behavior based on whether the user equipment is in the first radio coverage area, wherein the monitoring behavior may comprise a first monitoring behavior based on a determination that the user equipment is in the first radio coverage area, wherein the monitoring behavior may comprise a second monitoring behavior based on a determination that the user equipment is outside the first radio coverage area, wherein the first monitoring behavior may be at least partially different from the second monitoring behavior; and causing performance of the determined monitoring behavior.

In accordance with another example embodiment, a non-transitory computer-readable medium comprising instructions that, when executed by an apparatus, cause the apparatus to perform at least the following: receiving a configuration for monitoring behavior; determining whether a user equipment is in a first radio coverage area based, at least partially, on the received configuration; determining a monitoring behavior based on whether the user equipment is in the first radio coverage area, wherein the monitoring behavior may comprise a first monitoring behavior based on a determination that the user equipment is in the first radio coverage area, wherein the monitoring behavior may comprise a second monitoring behavior based on a determination that the user equipment is outside the first radio coverage area, wherein the first monitoring behavior may be at least partially different from the second monitoring behavior; and causing performance of the determined monitoring behavior.

A computer implemented system comprising: at least one processor and at least one non-transitory memory storing instructions that, when executed by the at least one processor, cause the system at least to perform: receiving a configuration for monitoring behavior; determining whether a user equipment is in a first radio coverage area based, at least partially, on the received configuration; determining a monitoring behavior based on whether the user equipment is in the first radio coverage area, wherein the monitoring behavior may comprise a first monitoring behavior based on a determination that the user equipment is in the first radio coverage area, wherein the monitoring behavior may comprise a second monitoring behavior based on a determination that the user equipment is outside the first radio coverage area, wherein the first monitoring behavior may be at least partially different from the second monitoring behavior; and causing performance of the determined monitoring behavior.

A computer implemented system comprising: means for receiving a configuration for monitoring behavior; means for determining whether a user equipment is in a first radio coverage area based, at least partially, on the received configuration; means for determining a monitoring behavior based on whether the user equipment is in the first radio coverage area, wherein the monitoring behavior may comprise a first monitoring behavior based on a determination that the user equipment is in the first radio coverage area, wherein the monitoring behavior may comprise a second monitoring behavior based on a determination that the user equipment is outside the first radio coverage area, wherein the first monitoring behavior may be at least partially different from the second monitoring behavior; and means for causing performance of the determined monitoring behavior.

In accordance with one example embodiment, an apparatus may comprise: at least one processor; and at least one memory storing instructions that, when executed by the at least one processor, cause the apparatus at least to: transmit, to a user equipment, a configuration for monitoring behavior, wherein the configuration may comprise, at least, an indication of network information associated with user equipment selection of monitoring behavior.

The configuration for monitoring behavior may be transmitted via at least one of: dedicated radio resource control signaling, or at least one system information block.

The network information may comprise at least one of: at least one rule defining a first radio coverage area, at least one parameter defining the first radio coverage area, at least one threshold value associated with a wake-up signal, at least one threshold value associated with a wake-up signal beacon, at least one rule defining a second radio coverage area, wherein the second radio coverage area is at least partially different from the first radio coverage area, at least one parameter defining the second radio coverage area, at least one threshold value associated with a synchronization signal block-based reference signal received power, at least one threshold value associated with a synchronization signal block-based reference signal received quality, at least one radio condition for wake-up signal monitoring, at least one radio condition for wake-up signal beacon monitoring, at least one radio condition for downlink control information based paging monitoring, at least one radio condition associated with a signal power of a downlink control information based paging signal, at least one radio condition associated with a signal quality of the downlink control information based paging signal, at least one radio condition associated with a signal power of a wake-up signal, at least one radio condition associated with a signal quality of a wake-up signal, at least one radio condition associated with a signal power of a wake-up signal beacon, or at least one radio condition associated with a signal quality of a wake-up signal beacon.

The network information may be associated with at least one of: the user equipment, a cell, or a specific beam.

The example apparatus may be further configured to: determine the network information.

The network information may be determined based, at least partially, on at least one of: one or more channel conditions, one or more measurements of radio signal strength, a minimum receiver performance associated with the user equipment, an offset applied to the minimum receiver performance associated with the user equipment, assistance information associated with a wake-up signal receiver of the user equipment, a wake-up signal radio frequency sensitivity level supported by the user equipment, or a last serving beam associated with the user equipment.

In accordance with one aspect, an example method may be provided comprising: transmitting, to a user equipment, a configuration for monitoring behavior, wherein the configuration may comprise, at least, an indication of network information associated with user equipment selection of monitoring behavior.

The configuration for monitoring behavior may be transmitted via at least one of: dedicated radio resource control signaling, or at least one system information block.

The network information may comprise at least one of: at least one rule defining a first radio coverage area, at least one parameter defining the first radio coverage area, at least one threshold value associated with a wake-up signal, at least one threshold value associated with a wake-up signal beacon, at least one rule defining a second radio coverage area, wherein the second radio coverage area is at least partially different from the first radio coverage area, at least one parameter defining the second radio coverage area, at least one threshold value associated with a synchronization signal block-based reference signal received power, at least one threshold value associated with a synchronization signal block-based reference signal received quality, at least one radio condition for wake-up signal monitoring, at least one radio condition for wake-up signal beacon monitoring, at least one radio condition for downlink control information based paging monitoring, at least one radio condition associated with a signal power of a downlink control information based paging signal, at least one radio condition associated with a signal quality of the downlink control information based paging signal, at least one radio condition associated with a signal power of a wake-up signal, at least one radio condition associated with a signal quality of a wake-up signal, at least one radio condition associated with a signal power of a wake-up signal beacon, or at least one radio condition associated with a signal quality of a wake-up signal beacon.

The network information may be associated with at least one of: the user equipment, a cell, or a specific beam.

The example method may further comprise: determining the network information.

The network information may be determined based, at least partially, on at least one of: one or more channel conditions, one or more measurements of radio signal strength, a minimum receiver performance associated with the user equipment, an offset applied to the minimum receiver performance associated with the user equipment, assistance information associated with a wake-up signal receiver of the user equipment, a wake-up signal radio frequency sensitivity level supported by the user equipment, or a last serving beam associated with the user equipment.

In accordance with one example embodiment, an apparatus may comprise: circuitry configured to perform: transmitting, to a user equipment, a configuration for monitoring behavior, wherein the configuration may comprise, at least, an indication of network information associated with user equipment selection of monitoring behavior.

In accordance with one example embodiment, an apparatus may comprise: processing circuitry; memory circuitry including computer program code, the memory circuitry and the computer program code configured to, with the processing circuitry, enable the apparatus to: transmit, to a user equipment, a configuration for monitoring behavior, wherein the configuration may comprise, at least, an indication network information associated with user equipment selection of monitoring behavior.

In accordance with one example embodiment, an apparatus may comprise means for performing: transmitting, to a user equipment, a configuration for monitoring behavior, wherein the configuration may comprise, at least, an indication of network information associated with user equipment selection of monitoring behavior.

The configuration for monitoring behavior may be transmitted via at least one of: dedicated radio resource control signaling, or at least one system information block.

The network information may comprise at least one of: at least one rule defining a first radio coverage area, at least one parameter defining the first radio coverage area, at least one threshold value associated with a wake-up signal, at least one threshold value associated with a wake-up signal beacon, at least one rule defining a second radio coverage area, wherein the second radio coverage area is at least partially different from the first radio coverage area, at least one parameter defining the second radio coverage area, at least one threshold value associated with a synchronization signal block-based reference signal received power, at least one threshold value associated with a synchronization signal block-based reference signal received quality, at least one radio condition for wake-up signal monitoring, at least one radio condition for wake-up signal beacon monitoring, at least one radio condition for downlink control information based paging monitoring, at least one radio condition associated with a signal power of a downlink control information based paging signal, at least one radio condition associated with a signal quality of the downlink control information based paging signal, at least one radio condition associated with a signal power of a wake-up signal, at least one radio condition associated with a signal quality of a wake-up signal, at least one radio condition associated with a signal power of a wake-up signal beacon, or at least one radio condition associated with a signal quality of a wake-up signal beacon.

The network information may be associated with at least one of: the user equipment, a cell, or a specific beam.

The means may be further configured to perform: determining the network information.

The network information may be determined based, at least partially, on at least one of: one or more channel conditions, one or more measurements of radio signal strength, a minimum receiver performance associated with the user equipment, an offset applied to the minimum receiver performance associated with the user equipment, assistance information associated with a wake-up signal receiver of the user equipment, a wake-up signal radio frequency sensitivity level supported by the user equipment, or a last serving beam associated with the user equipment.

In accordance with one example embodiment, a non-transitory computer-readable medium comprising instructions stored thereon which, when executed with at least one processor, cause the at least one processor to: cause transmitting, to a user equipment, of a configuration for monitoring behavior, wherein the configuration may comprise, at least, an indication of network information associated with user equipment selection of monitoring behavior.

In accordance with one example embodiment, a non-transitory computer-readable medium comprising program instructions stored thereon for performing at least the following: causing transmitting, to a user equipment, of a configuration for monitoring behavior, wherein the configuration may comprise, at least, an indication of network information associated with user equipment selection of monitoring behavior.

In accordance with another example embodiment, a non-transitory program storage device readable by a machine may be provided, tangibly embodying instructions executable by the machine for performing operations, the operations comprising: causing transmitting, to a user equipment, of a configuration for monitoring behavior, wherein the configuration may comprise, at least, an indication of network information associated with user equipment selection of monitoring behavior.

In accordance with another example embodiment, a non-transitory computer-readable medium comprising instructions that, when executed by an apparatus, cause the apparatus to perform at least the following: causing transmitting, to a user equipment, of a configuration for monitoring behavior, wherein the configuration may comprise, at least, an indication of network information associated with user equipment selection of monitoring behavior.

A computer implemented system comprising: at least one processor and at least one non-transitory memory storing instructions that, when executed by the at least one processor, cause the system at least to perform: cause transmitting, to a user equipment, of a configuration for monitoring behavior, wherein the configuration may comprise, at least, an indication of network information associated with user equipment selection of monitoring behavior.

A computer implemented system Comprising: means for causing transmitting, to a user equipment, of a configuration for monitoring behavior, wherein the configuration may comprise, at least, an indication of network information associated with user equipment selection of monitoring behavior.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1. An apparatus comprising:
at least one processor; and
at least one memory storing instructions that, when executed by the at least one processor, cause the apparatus at least to:
receive a configuration for monitoring behavior;
determine whether the apparatus is in a first radio coverage area based, at least partially, on the received configuration;
determine a monitoring behavior based on whether the apparatus is in the first radio coverage area, wherein the monitoring behavior comprises a first monitoring behavior based on a determination that the apparatus is in the first radio coverage area, wherein the monitoring behavior comprises a second monitoring behavior based on a determination that the apparatus is outside the first radio coverage area, wherein the first monitoring behavior is at least partially different from the second monitoring behavior; and
perform the determined monitoring behavior.

2. The apparatus of claim 1, wherein the configuration for monitoring behavior comprises an indication of at least one of:
at least one rule defining the first radio coverage area,
at least one parameter defining the first radio coverage area,
at least one threshold value associated with a wake-up signal,
at least one threshold value associated with a wake-up signal beacon,
at least one rule defining a second radio coverage area, wherein the second radio coverage area is at least partially different from the first radio coverage area,
at least one parameter defining the second radio coverage area,
at least one threshold value associated with a synchronization signal block-based reference signal received power,
at least one threshold value associated with a synchronization signal block-based reference signal received quality,
at least one radio condition for wake-up signal monitoring,
at least one radio condition for wake-up signal beacon monitoring,
at least one radio condition for downlink control information based paging monitoring,
at least one radio condition associated with a signal power of a downlink control information paging signal,
at least one radio condition associated with a signal quality of the downlink control information paging signal,
at least one radio condition associated with a signal power of a wake-up signal,
at least one radio condition associated with a signal quality of a wake-up signal,
at least one radio condition associated with a signal power of a wake-up signal beacon, or
at least one radio condition associated with a signal quality of a wake-up signal beacon.

3. The apparatus of claim 2, wherein the at least one memory, storing the instructions, when executed by the at least one processor, causes the apparatus to: determine whether to change the determined monitoring behavior based, at least partially, on the received configuration.

4. The apparatus of claim 3, wherein the determined monitoring behavior comprises the first monitoring behavior, wherein determining whether to change the determined monitoring behavior comprises the at least one memory, storing the instructions, when executed by the at least one processor, causes the apparatus to:
determine that the apparatus has moved outside the first radio coverage area based on at least one of:
a determination that a number of failed attempts to receive a wake-up signal or wake-up signal beacon meets or exceeds a predetermined number,
a determination that a power of at least one received wake-up signal or at least one wake-up signal beacon is below at least one first threshold value,
a determination that a quality of the at least one received wake-up signal or the at least one wake-up signal beacon is below at least one second threshold value, or
a determination that a reference signal received power measurement of at least one synchronization signal block is below at least one third threshold value;
determine to change the determined monitoring behavior to the second monitoring behavior in response to the determination that the apparatus has moved outside the first radio coverage area; and
perform the second monitoring behavior,
wherein the received configuration comprises at least one of:
an indication of the predetermined number,
an indication of the at least one first threshold value,
an indication of the at least one second threshold value, or
an indication of the at least one third threshold value.

5. The apparatus of claim 3, wherein the determined monitoring behavior comprises the second monitoring behavior, wherein determining whether to change the determined monitoring behavior comprises the at least one memory, storing the instructions, when executed by the at least one processor, causes the apparatus to:
determine that that the apparatus has moved within the first radio coverage area based on at least one of:
a determination that a wake-up signal or a wake-up signal beacon has been detected,
a determination that a power of at least one received wake-up signal or at least one received wake-up signal beacon meets or exceeds at least one first threshold value,
a determination that a quality of the at least one received wake-up signal or the at least one received wake-up signal beacon meets or exceeds at least one second threshold value, or
a determination that a reference signal received power measurement of at least one synchronization signal block meets or exceeds at least one third threshold value;
determine to change the determined monitoring behavior to the first monitoring behavior in response to the determination that the apparatus has moved within the first radio coverage area; and
perform the first monitoring behavior,
wherein the received configuration comprises at least one of:
an indication of the at least one first threshold value,
an indication of the at least one second threshold value, or
an indication of the at least one third threshold value.

6. The apparatus of claim 1, wherein determining whether the apparatus is in the first radio coverage area comprises the at least one memory, storing the instructions, when executed by the at least one processor, causes the apparatus to:
perform at least one measurement;
compare the at least one measurement to at least one threshold, wherein the received configuration comprises, at least, an indication of the at least one threshold; and
determine whether the apparatus is in the first radio coverage area based on a result of the comparing.

7. The apparatus of claim 1, wherein the at least one memory, storing the instructions, when executed by the at least one processor, causes the apparatus to:
transmit, to a network, assistance information, wherein the assistance information comprises an indication of at least one of:
a minimum wake-up signal or wake-up signal beacon received power level,
a minimum wake-up signal or wake-up signal beacon received power sensitivity,
a location of the apparatus with respect to the first radio coverage area,
a minimum receiver performance of the apparatus,
information associated with a wake-up signal receiver of the apparatus,
a wake-up signal radio frequency sensitivity level supported by the apparatus, or
a last serving beam associated with the apparatus.

8. A method comprising:
receiving, with a user equipment, a configuration for monitoring behavior;
determining whether the user equipment is in a first radio coverage area based, at least partially, on the received configuration;
determining a monitoring behavior based on whether the user equipment is in the first radio coverage area, wherein the monitoring behavior comprises a first monitoring behavior based on a determination that the user equipment is in the first radio coverage area, wherein the monitoring behavior comprises a second monitoring behavior based on a determination that the user equipment is outside the first radio coverage area, wherein the first monitoring behavior is at least partially different from the second monitoring behavior; and
performing, with the user equipment, the determined monitoring behavior.

9. A non-transitory computer-readable medium comprising program instructions stored thereon for performing at least the following:
receiving a configuration for monitoring behavior;
determining whether a user equipment is in a first radio coverage area based, at least partially, on the received configuration;
determining a monitoring behavior based on whether the user equipment is in the first radio coverage area, wherein the monitoring behavior comprises a first monitoring behavior based on a determination that the user equipment is in the first radio coverage area, wherein the monitoring behavior comprises a second monitoring behavior based on a determination that the user equipment is outside the first radio coverage area, wherein the first monitoring behavior is at least partially different from the second monitoring behavior; and
causing performance of the determined monitoring behavior.

10-16. (canceled)

17. The method of claim 8, wherein the configuration for monitoring behavior comprises an indication of at least one of:
at least one rule defining the first radio coverage area,
at least one parameter defining the first radio coverage area,
at least one threshold value associated with a wake-up signal,
at least one threshold value associated with a wake-up signal beacon,
at least one rule defining a second radio coverage area, wherein the second radio coverage area is at least partially different from the first radio coverage area,
at least one parameter defining the second radio coverage area,
at least one threshold value associated with a synchronization signal block-based reference signal received power,
at least one threshold value associated with a synchronization signal block-based reference signal received quality,
at least one radio condition for wake-up signal monitoring,
at least one radio condition for wake-up signal beacon monitoring,
at least one radio condition for downlink control information based paging monitoring,
at least one radio condition associated with a signal power of a downlink control information paging signal,
at least one radio condition associated with a signal quality of the downlink control information paging signal,
at least one radio condition associated with a signal power of a wake-up signal,
at least one radio condition associated with a signal quality of a wake-up signal,
at least one radio condition associated with a signal power of a wake-up signal beacon, or
at least one radio condition associated with a signal quality of a wake-up signal beacon.

18. The method of claim 17, further comprising:
determining whether to change the determined monitoring behavior based, at least partially, on the received configuration.

19. The method of claim 18, wherein the determined monitoring behavior comprises the first monitoring behavior, wherein determining whether to change the determined monitoring behavior comprises:
determining that the user equipment has moved outside the first radio coverage area based on at least one of:
a determination that a number of failed attempts to receive a wake-up signal or wake-up signal beacon meets or exceeds a predetermined number,
a determination that a power of at least one received wake-up signal or at least one wake-up signal beacon is below at least one first threshold value,
a determination that a quality of the at least one received wake-up signal or the at least one wake-up signal beacon is below at least one second threshold value, or
a determination that a reference signal received power measurement of at least one synchronization signal block is below at least one third threshold value;
determining to change the determined monitoring behavior to the second monitoring behavior in response to the determination that the user equipment has moved outside the first radio coverage area; and
performing the second monitoring behavior,
wherein the received configuration comprises at least one of:
an indication of the predetermined number,
an indication of the at least one first threshold value,
an indication of the at least one second threshold value, or
an indication of the at least one third threshold value.

20. The method of claim 18, wherein the determined monitoring behavior comprises the second monitoring behavior, wherein determining whether to change the determined monitoring behavior comprises:
determining that that the user equipment has moved within the first radio coverage area based on at least one of:
a determination that a wake-up signal or a wake-up signal beacon has been detected,
a determination that a power of at least one received wake-up signal or at least one received wake-up signal beacon meets or exceeds at least one first threshold value,
a determination that a quality of the at least one received wake-up signal or the at least one received wake-up signal beacon meets or exceeds at least one second threshold value, or
a determination that a reference signal received power measurement of at least one synchronization signal block meets or exceeds at least one third threshold value;
determining to change the determined monitoring behavior to the first monitoring behavior in response to the determination that the user equipment has moved within the first radio coverage area; and
performing the first monitoring behavior,
wherein the received configuration comprises at least one of:
an indication of the at least one first threshold value,
an indication of the at least one second threshold value, or
an indication of the at least one third threshold value.

21. The method of claim 8, wherein determining whether the user equipment is in the first radio coverage area comprises:
performing at least one measurement;
comparing the at least one measurement to at least one threshold, wherein the received configuration comprises, at least, an indication of the at least one threshold; and
determining whether the user equipment is in the first radio coverage area based on a result of the comparing.

22. The method of claim 8, comprising:
transmitting, to a network, assistance information, wherein the assistance information comprises an indication of at least one of:
a minimum wake-up signal or wake-up signal beacon received power level,
a minimum wake-up signal or wake-up signal beacon received power sensitivity,
a location of the user equipment with respect to the first radio coverage area,
a minimum receiver performance of the user equipment,
information associated with a wake-up signal receiver of the user equipment,
a wake-up signal radio frequency sensitivity level supported by the user equipment, or
a last serving beam associated with the user equipment.
